(19) United States
(12) Patent Application Publication
(10) Pub. No.: US 2010/0125114 A1
(43) Pub. Date: May 20, 2010

(54) Propylene-Based Film Compositions

(76) Inventors: Michael G. Williams, Houston, TX (US); Hans J. Pip, Overijse (BE)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 12/271,539

(22) Filed: Nov. 14, 2008

(51) Int. Cl. C08K 5/20; B29C 43/00

(52) U.S. Cl. 524/231; 524/210; 264/555; 264/211.12

(57) ABSTRACT

A film comprising at least one layer which comprises a propylene-alpha-olefin copolymer, greater than or equal to 0.10 wt % of a first modifier, and greater than or equal to 0.50 wt % of a second modifier, based on the weight of the layer. The propylene-alpha-olefin copolymer comprises propylene-derived units and from 5 to 35 wt %, based on the weight of the copolymer, of units derived from ethylene and/or C4 to C10 alpha-olefins. The first modifier comprises a first unsaturated amide-containing slip agent. The second modifier is selected from: i) a second unsaturated amide-containing slip-agent, which may be the same or different than the first unsaturated amide-containing slip-agent; ii) a saturated amide-containing slip agent; iii) an antiblock; and iv) a mixture of any two or more of i, ii, and iii. The film exhibits reduced tackiness and reduced roll blocking.

### FIELD OF THE INVENTION

This invention relates to propylene-based film compositions. More particularly, this invention relates to films comprising propylene-alpha-olefin copolymers and amide-containing slip agents.

### BACKGROUND OF THE INVENTION

Plastic films have found utility in a wide variety of applications, such as packaging applications (e.g., bags, pouches, tubes, and trays) and also in absorbent articles where strength and elasticity are needed. Polypropylene films often do not have the desired elasticity that is needed for certain applications, thus, propylene-alpha-olefin copolymers, such as propylene-ethylene copolymers, are often used. While copolymers with higher alpha-olefin content provide more elasticity to the film, the films can become very tacky and soft. Even after low temperature quenching, the film can remain extremely tacky and may tend to stick to downstream film processing equipment as well as to itself during winding (e.g., roll blocking), narrowing the winding processing window that may be used. Once roll blocking has occurred, the film roll can become difficult, if not impossible, to unwind without damaging the film.

A thin plastic layer may be extruded as an outer layer on the film composition, covering a core layer containing the propylene-alpha-olefin copolymer. The outer “skin” layer may protect the core layer and limit the film's tackiness. However, a skin layer is not always desirable, as it may reduce the elastic property of the film, and may also limit the end-use applications of the film composition.

Antiblock additives and slip agents have been used in polyolefin-based plastic films to limit film tackiness and roll-blocking. However, propylene-alpha-olefin copolymers, particularly propylene-ethylene copolymers, can be much tackier than conventional film forming polyolefins, such as polyethylene and polypropylene. Thus, the use of conventional antiblock additives and/or slip agents in conventional amounts are not sufficient when the outermost layer of the film contains a propylene-ethylene copolymer, particularly one with high ethylene content.

Therefore, a need exists for a film comprising propylene-alpha-olefin copolymers which maintains desired strength and elastic properties, and which exhibits reduced film tackiness and roll-blocking. For some end-uses some level of residual “tackiness” is desirable, thus, there is also a need for a way to tailor the film's tackiness for various end-uses.

### SUMMARY OF THE INVENTION

In one aspect, this disclosure relates to a film having a coefficient of friction of less than or equal to 0.80. The film comprises at least one layer which comprises a propylene-alpha-olefin copolymer, a first modifier in an amount greater than or equal to 0.10 wt %, and second modifier in an amount greater than or equal to 0.50 wt %, based on the weight of the layer. In one embodiment, the layer is one of the outermost layers of the film.

In another aspect, this disclosure relates to a method of forming a film comprising the steps of melt blending a propylene-alpha-olefin copolymer and an additive masterbatch, extruding the melt blend through one or more extruder dies, and forming a blown or cast film. The additive masterbatch comprises a polymer carrier, a first modifier in an amount greater than or equal to 0.10 wt %, and a second modifier in an amount greater than or equal to 0.50 wt %, based on the weight of the melt-blend.

In one embodiment, and in combination with any of the above disclosed aspects or embodiments, the propylene-alpha-olefin copolymer comprises propylene-derived units and from 5 to 35 wt %, based on the weight of the copolymer, of units derived from ethylene and/or C4 to C10 alpha-olefins and has a melt flow rate, as determined by ASTM D1238 at 230° C., in the range of 0.5 to 50 dg/min and a heat of fusion (Hf) of less than 75 J/g.

In one embodiment, and in combination with any of the above disclosed aspects or embodiments, the first modifier comprises a first unsaturated amide-containing slip agent.

In another embodiment, and in combination with any of the above disclosed aspects or embodiments, the second modifier is selected from: i) a second unsaturated amide-containing slip-agent, which may be the same or different than the first unsaturated amide-containing slip-agent; ii) a saturated amide-containing slip agent; iii) an antiblock; and iv) a mixture of any two or more of i, ii, and iii.

These and other features, aspects, and advantages of the present disclosure will become better understood with regard to the following description and appended claims.

### DETAILED DESCRIPTION OF THE INVENTION

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

Provided herein are propylene-based film compositions. The films comprise propylene-alpha-olefin copolymers. In a preferred embodiment, the propylene-alpha-olefin copolymer consists essentially of units derived from propylene and ethylene. In one embodiment, the propylene-alpha-olefin copolymers have an ethylene comonomer content in the range of 5 wt % to 35 wt %, based on the weight of the copolymer. In another embodiment, the copolymer has a crystallinity in the range of 0.5 to 40% and a triad tacticity (of three propylene units) of 75% or more. In other embodiments, the copolymer has a melt flow rate in the range of 0.5 to 50 dg/min and a heat of fusion less than 75 J/g. The film may further comprise one or more amide-containing slip agents, and in some embodiments may also comprise an antiblocking agent.

### Propylene-Alpha-Olefin Copolymers

The “propylene-alpha-olefin copolymers” described herein are copolymers of propylene-derived units and one or more units derived from ethylene or a C₄-C₁₀ alpha-olefin and, optionally, one or more diene-derived units. Typical comonomer content of the copolymer is from 5 to 35 wt %. In general, the comonomer content is adjusted so that the copolymer preferably has a heat of fusion (Hf) of less than or equal to 75 J/g and a MFR in the range of 0.5 to 50 dg/min.

In some embodiments, when more than one comonomer is present, the amount of a particular comonomer may be less than 5 wt %, but the combined comonomer content is preferably greater than 5 wt %. When there is more than comonomer unit in the copolymer, the total weight percent of the ethylene or C4-C10 alpha-olefin derived units is preferably in the range of 5 to 35 wt %, or in the range of 7 to 32 wt %, or preferably in the range of 8 to 25 wt %, or more preferably in the range of 8 to 20 wt %, or most preferably in the range of 8 to 18 wt %. Particular embodiments of copolymers having more than one comonomer units include propylene-ethylene-octene, propylene-ethylene-hexene, and propylene-ethylene-butene polymers. These copolymers may further comprise a diene.

In one embodiment, the propylene-alpha-olefin copolymer comprises propylene-derived units and comonomer-derived units selected from ethylene, 1-hexene, and 1-octene. The copolymer may comprise comonomer-derived units in an amount in the range of 5 to 25 wt %, or in the range of 5 to 20 wt %, or in the range of 5 to 16 wt %, or in the range of 6 to 18 wt %, or in some embodiments in the range of 8 to 20 wt % comonomer-derived units, based on the weight of the copolymer.

In another embodiment, the copolymer comprises ethylene-derived units. In some embodiments, the copolymer consists essentially of units derived from propylene and ethylene. The copolymer may comprise 5 to 35 wt % of ethylene-derived units or 5 to 20 wt % of ethylene-derived units, based on the total weight of the copolymer. In one embodiment, the copolymer comprises 10 to 12 wt % of ethylene-derived units, based on the total weight of the copolymer. In another embodiment, the copolymer comprises 15 to 20 wt % of ethylene-derived units, based on the total weight of the copolymer.

The propylene-alpha-olefin copolymer may optionally comprise less than or equal to 10 wt % diene-derived units (or “diene”), or less than or equal to 5 wt % diene, or preferably less than or equal to 3 wt % diene. In some embodiments the diene is present in the range of 0.1 to 6 wt %, or in the range of 0.1 to 5 wt %, or preferably in the range of 0.1 to 4 wt %, or more preferably in the range of 0.1 to 2 wt %, or most preferably in the range of 0.1 to 1 w %. Suitable dienes include, but are not limited to: 1,4-hexadiene, 1,6-octadiene, 5-methyl-1,4-hexadiene, 3,7-dimethyl-1,6-octadiene, dicyclopentadiene (“DCPD”), ethylidiene norbornene (“ENB”), norbornadiene, 5-vinyl-2-norbornene (“VN”), and combinations thereof. The diene, if present, is preferably ENB.

The propylene-alpha-olefin copolymer may have a triad tacticity of three propylene units, as measured by ¹³C NMR, of 75% or more, or 80% or more, or 82% or more, or 85% or more, or in some embodiments 90% or more. Preferably the triad tacticity is in the range of 50 to 99%, or in the range of 60 to 99%, or more preferably in the range of 75 to 99%, or in the range of 80 to 99%, or in other embodiments in the range of 60 to 97%.

In one embodiment, the propylene-alpha-olefin copolymer has a heat of fusion (“Hf”), as determined by the Differential Scanning Calorimetry (“DSC”) procedure described herein, of greater than or equal to 0.5 J/g, or 1 J/g, or 5 J/g and is less than or equal to 75 J/g, or preferably less than or equal to 70 J/g, or 50 J/g, or less than or equal to 35 J/g. Stated another way, in one or more embodiments, the Hf value may be within the range of 1.0, or 1.5, or 3.0, or 4.0, or 6.0, or 7.0 J/g to 30, or 35, or 40, or 50, or 60, or 70, or 75, or 80 J/g.

The propylene-alpha-olefin copolymer may have a percent crystallinity within the range of 0.5 to 40%, or in the range of 1 to 30%, or preferably in the range of 5 to 35%, wherein “percent crystallinity” is determined according to the DSC procedure described herein. The thermal energy for the highest order of propylene is estimated at 189 J/g (i.e., 100% crystallinity is equal to 189 J/g). In some embodiments, the copolymer has a crystallinity less than 40%, or in the range of 0.25 to 25%, or in the range of 0.5 to 22%.

The propylene-alpha-olefin copolymer may have a single peak melting transition as determined by DSC. In one embodiment, the copolymer has a primary peak transition of less than about 90° C., with a broad end-of-melt transition of greater than about 110° C. The peak “melting point” (“Tm”) is defined as the temperature of the greatest heat absorption within the range of melting of the sample. However, the copolymer may show secondary melting peaks adjacent to the principal peak, and/or at the end-of-melt transition, however for the purposes herein, such secondary melting peaks are considered together as a single melting point, with the highest of these peaks being considered the Tm of the propylene-alpha-olefin copolymer. The propylene-alpha-olefin copolymer may have a Tm of less than or equal to 70° C., or less than or equal to 80° C., or less than or equal to 90° C., or less than or equal to 100° C., or in one embodiment in the range of 25 to 100° C., or in the range of 25 to 85° C., or in the range of 25 to 75° C., or in the range of 25 to 65° C., or in the range of 30 to 80° C., or in the range of 30 to 70° C.

The propylene-alpha-olefin copolymer may have a density within the range of 0.850 to 0.920 g/cm³, or in the range of 0.860 to 0.900 g/cm³, or preferably in the range of 0.860 to 0.890 g/cm³ at room temperature as measured per the ASTM D-1505 test method.

The propylene-alpha-olefin copolymer may have a melt flow rate (“MFR”, ASTM D1238, 2.16 kg, 230° C.), greater than or equal to 0.2 dg/min. In one embodiment, the propylene-alpha-olefin copolymer's MFR is in the range of 0.5 to 5000 dg/min, or more preferably in the range of 1 to 2500 dg/min, or in the range of 1.5 to 1500 dg/min, or in the range of 2 to 1000 dg/min, or in the range of 5 to 500 dg/min, or in the range of 10 to 250 dg/min, or in the range of 10 to 100 dg/min, or in the range of 2 to 40 dg/min, or in the range of 2 to 30 dg/min. In some embodiments, the copolymer's MFR is in the range of 0.5 to 50 dg/min, or in the range of 1 to 30 dg/min, or in the range of 2 to 10 dg/min.

The propylene-alpha-olefin copolymer may posses an Elongation at Break (ASTM D412) of less than 2000%, or less than 1000%, less than 800%.

The propylene-alpha-olefin copolymer may have a Mw in the range of 5,000 to 5,000,000 g/mole, or preferably in the range of 10,000 to 1,000,000 g/mole, or more preferably in the range of 50,000 to 400,000 g/mole. The copolymer may have a Mn in the range of 2,500 to 2,500,00 g/mole, or preferably in the range of 10,000 to 250,000 g/mole, or more preferably in the range of 25,000 to 200,000 g/mole. The copolymer may have a Mz within the range of 10,000 to 7,000,000 g/mole, or preferably in the range of 80,000 to 700,000 g/mole, or more preferably in the range of 100,000 to 500,000 g/mole.

The propylene-alpha-olefin copolymer may have a molecular weight distribution (“MWD”) within the range of 1.5 to 20, or in the range of 1.5 to 15, or preferably in the range of 1.5 to 5, or more preferably in the range of 1.8 to 5, or most preferably in the range of 1.8 to 3 or 4.

The propylene-alpha-olefin copolymers can include copolymers prepared according to the procedures in WO 02/36651, U.S. Pat. No. 6,992,158, and/or WO 00/01745, all of which are herein incorporated by reference. Preferred methods for producing the propylene-alpha-olefin copolymers are found in U.S. Pat. No. 7,232,871 and U.S. Pat. No. 6,881,800, both of which are herein incorporated by reference. Preferred propylene-alpha-olefin copolymers are available commercially under the trade names VISTAMAXX™ (ExxonMobil Chemical Company, Houston, Tex., USA) and VERSIFY™ (The Dow Chemical Company, Midland, Mich., USA), certain grades of TAFMER™ XM or NOTIO™ (Mitsui Company, Japan), and certain grades of SOFTEL™ (Basell Polyolefins of the Netherlands).

In the films described herein, there can be one or more different propylene-alpha-olefin copolymers, “different” meaning that the copolymers each have one or more different properties, such as, a different comonomer content, comonomer identity, and/or some other distinct property, but such that all of the propylene-alpha-olefin copolymers fall within the broadest description of those copolymers described herein.

### Slip-Agents

The film further comprises a slip agent. A “slip-agent” is a compound or mixture of compounds that are useful when added to polyolefin compositions, wherein upon addition to the polyolefin it will facilitate the polymer's removal from, for example, a mold or other surface. In one embodiment, the slip-agent may be an organic amine compound (containing an amine group with hydrocarbon groups bound thereto). In another embodiment, the slip-agent is a fatty acid amine or a fatty acid amide. In some embodiments, the slip-agent may have one or more paraffinc or olefinic groups bound to a nitrogen atom, forming an amine or an amide compound. The paraffinic or olefinic group may be, for example, a polar or ionic moiety as a side chain or within the amine/amide backbone. Such polar or ionic moieties can include hydroxyl groups, carboxylate groups, ether groups, ester groups, sulfonate groups, sulfite groups, nitrate groups, nitrite groups, phosphate groups, phosphate groups, and combinations thereof.

In one embodiment, the slip-agent is an alkyl-ether amine having the following formula: (R′OH)₃₋ₓNRₓ, wherein R is selected from the group consisting of hydrogen atoms, C₁ to C₄₀ alkyl radicals, C₂ to C₄₀ alkylethers, C₁ to C₄₀ alkylcarboxylic acids, and C₂ to C₄₀ alkylesters; and R′ is selected from C₁ to C₄₀ alkyl radicals, C₂ to C₄₀ alkylethers, C₁ to C₄₀ carboxylic acids, and C₂ to C₄₀ alkylesters; and wherein x is 0, 1, 2 or 3; preferably x is 0 or 1, and is 1 in a particular embodiment. In yet another embodiment, the R group is selected from the group consisting of hydrogen atoms and C₅ to C₄₀ alkyl radicals; and the R′ is selected from C₅ to C₄₀ alkyl radicals and C₅ to C₄₀ alkylethers.

In another embodiment, the slip-agent is an amide-containing slip agent having the following formula: RCONH₂, wherein R is a C₅-C₂₃ alkyl or alkene.

In another embodiment, the slip-agent is an fatty acid amide having the following formula: (R′CO)₃₋ₓNR″ₓ, wherein R″ is selected from the group consisting of hydrogen atoms, C₁₀ to C₆₀ alkyl radicals and C₁₀ to C₆₀ alkene radicals, and substituted versions thereof, and R′ is selected from C₁₀ to C₆₀ alkyl radicals, and C₁₀ to C₆₀ alkene radicals and substituted versions thereof, and wherein x is 0, 1, 2 or 3; preferably x is 1 or 2, and is 2 in a particular embodiment. In this embodiment, an “alkene” radical is one wherein one or more double-bond unsaturation occurs in the radical chain (e.g., —CH₂CH₂CH₂CH₂CH═CHCH₂CH₂CH₂CH₂CH₂CH₃). By “substituted,” what is meant is a substitution at some point along the hydrocarbon chain of a hydroxyl group, carboxyl group, a halide, or a sulfate group.

Non-limiting examples of useful slip-agents include bis(2-hydroxyethyl) isodecyloxypropylamine, poly(5)oxyethylene isodecyloxypropylamine, bis(2-hydroxyethyl) isotridecyloxypropylamine, poly(5)oxyethylene isotridecyloxypropylamine, bis(2-hydroxyethyl) linear alkyloxypropylamine, bis(2-hydroxyethyl) soya amine, poly(15)oxyethylene soya amine, bis(2-hydroxyethyl)octadecylamine, poly(5)oxyethylene octadecylamine, poly(8)oxyethylene octadecylamine, poly(10)Oxyethylene octadecylamine, poly(15)oxyethylene octadecylamine, bis(2-hydroxyethyl)octadecyloxypropylamine, bis(2-hydroxyethyl)tallow amine, poly(5)oxyethylene tallow amine, poly(15)oxyethylene tallow amine, poly(3)oxyethylene-1,3-diaminopropane, bis(2-hydroxyethyl)cocoamine, bis(2-hydroxyethyl)isodecyloxypropylamine, poly(5)oxyethylene isodecyloxypropylamine, bis(2-hydroxyethyl)isotridecyloxypropylamine, poly(5)oxyethylene isotridecyloxypropylamine, bis(2-hydroxyethyl)linear alkyloxypropylamine, bis(2-hydroxyethyl)soya amine, poly(15)oxyethylene soya amine, bis(2-hydroxyethyl)octadecylamine, poly(5)oxyethylene octadecylamine, poly(8)oxyethylene octadecylamine, poly(10)Oxyethylene octadecylamine, poly(15)oxyethylene octadecylamine, bis(2-hydroxyethyl)octadecyloxypropylamine, bis(2-hydroxyethyl)tallow amine, poly(5)oxyethylene tallow amine, poly(15)oxyethylene tallow amine, poly(3) oxyethylene-1,3-diaminopropane, bis(2-hydroxethyl)cocoamine, valeramide, caproicamide, erucamide, caprylicamide, pelargonicamide, capricamide, lauricamide, lauramide, myristicamide, myristamide, palmiticamide, palmitoleamide, palmitamide, margaric (daturic) amide, stearicamide, arachidicamide, behenicamide, behenamide, lignocericamide, linoleamide, ceroticamide, carbocericamide, montanicamide, melissicamide, lacceroicamide, ceromelissic (psyllic) amide, geddicamide, 9-octadecenamide, oleamide, stearamide, tallow bis(2-hydroxyethyl)amine. cocobis(2-hydroxyethyl)amine, octadecylbis(2-hydroxyethyl)amine, oleylbis(2-hydroxyethyl)amine, ceroplastic amide, and combinations thereof. Commercial examples of useful slip-agents include ATMER™ compounds (Ciba Specialty Chemicals), ARMID™, ARMOFILM™ and ARMOSLIP™ compounds and NOURYMIX™ concentrates (Akzo Nobel Chemicals), and CRODAMIDE™ compounds (Croda Universal Inc.).

In one embodiment, the film comprises an unsaturated amide-containing slip agent. The unsaturated amide-containing slip agent may be selected from compounds having the following formula: RCONH₂, wherein R is a C₅-C₂₃ alkene. The unsaturated amide-containing slip agent may also be selected form compounds having the following formula: (R′CO)₃₋ₓNR″ₓ, wherein R″ is selected from the group consisting of hydrogen atoms, C₁₀ to C₆₀ alkyl radicals and C₁₀ to C₆₀ alkene radicals, and substituted versions thereof, and R′ is selected from C₁₀ to C₆₀ alkene radicals and substituted versions thereof, and wherein x is 0, 1, 2 or 3; preferably x is 1 or 2, and is 2 in a particular embodiment. In some embodiments, the unsaturated amide-containing slip agent may be selected from palmitoleamide, oleamide, linoleamide, erucamide, and mixtures thereof. In other embodiments, the unsaturated amide-containing slip agent may be oleamide, erucamide, or mixtures thereof.

In another embodiment, the film comprises a saturated amide-containing slip agent. The saturated amide-containing slip agent may be selected from compounds having the formula: RCONH₂, wherein R is a C₅-C₂₃ alkyl. The saturated amide-containing slip agent may also be selected from compounds having the following formula: (R′CO)₃₋ₓNR″ₓ, wherein R″ is selected from the group consisting of hydrogen atoms, C₁₀ to C₆₀ alkyl radicals and C₁₀ to C₆₀ alkene radicals, and substituted versions thereof, and R′ is selected from C₁₀ to C₆₀ alkyl radicals and substituted versions thereof, and wherein x is 0, 1, 2 or 3; preferably x is 1 or 2, and is 2 in a particular embodiment. In some embodiments, the saturated amide-containing slip agent may be selected from lauramide, myristamide, palmitamide, stearamide, behenamide, and mixtures thereof. In other embodiments, the saturated amide-containing slip agent may be selected from stearamide, behenamide, and mixtures thereof.

In the films described herein, there can be one or more different slip-agents, “different” meaning that the slip-agents each have a different structure and/or some other distinct property, but such that all of the slip-agents fall within the broadest description of those agents herein. For example, in one embodiment, the film may comprise one or more unsaturated amide-containing slip-agents, or in another embodiment, one or more unsaturated amide-containing slip agents and one or more saturated amide-containing slip agent. In one embodiment, it may be useful to use a combination of an unsaturated amide-containing slip-agent, such as erucamide or oleamide, and a saturated amide-containing slip agent, such as behenamide or stearamide. In other embodiments, it may be useful to use a combination of a low molecular weight (Mw) and a higher molecular weight (Mw) amide-containing slip agent.

In one embodiment, the film may comprise one or more slip agents in a total amount ranging from 0.01 to 20 wt % by weight of the layer in which contains the slip agent, or in the range of 0.05 to 15 wt %, or in the range of 0.10 to 10 wt %, or in the range of 0.15 to 8 wt %, or in the range of 0.50 to 5 wt %, wherein a desirable range may comprise any upper limit described herein with any lower limit described herein. In another embodiment, the film comprises at least 500 ppm of slip-agent, or at least 1000 ppm of slip-agent, or at least 1500 ppm, or preferably at least 2000 ppm, or at least 2500 ppm, or at least 3000 ppm, or at least 5000 ppm, or at least 7500 ppm, or at least 10,000 ppm, or 15,000 ppm of slip-agent.

The slip agent can be added to the composition in neat form, diluted, and/or as a masterbatch in, for example, polyolefin polymers, such as polypropylene, polystyrene, low density polyethylene, high density polyethylene, or propylene-alpha-olefin copolymers.

### Antiblock

The film may comprise an anti-blocking agent. As used herein, an “anti-block” agent is any compound or mixture of compounds, minerals, treated minerals, etc. that are used in polyolefins to reduce the tackiness of the polyolefin, especially as used in polyolefin films. In some embodiments, anti-blocking agents include porous inorganic oxide materials, such as metal oxides of Group 2, 3, 4, 5, 13, or 14 elements from the Periodic Table of Elements. Preferred metal oxides contain elements from Groups 4, 13, and 14. Non-limiting examples of suitable anti-block agents include silica, alumina, silica-alumina, and mixtures thereof. Other inorganic oxides that may be employed either alone or in combination with the silica, alumina, or silica-alumina include magnesia, titania, zirconia, and the like. One non-limiting example of a commercially available suitable anti-blocking agent is Sibelite™ M4000 (Sibelco), a high purity silica.

In one embodiment, the anti-blocking agent comprises silica or diatomaceous earth, with silica being preferred. In another embodiment, the anti-blocking agent does not comprise talc.

In one embodiment, the film consists of one anti-block agent, while in other embodiments, the film may include one or more different anti-block agents. In one embodiment, the film comprises anti-block agent in the range of 0.50 to 20 wt % by weight of the layer containing the anti-block agent, or in the range of 1 to 15 wt %, or in the range of 1.5 to 10 wt %, or in the range of 2.5 to 6.5 wt %, or in other embodiments in the range of 2 to 8 wt %, or where a desirable range may comprise any upper limit described herein with any lower limit described herein. In some embodiments, the composition comprises at least 1 wt % of anti-block, or at least 1.5 wt %, or at least 2 wt %, or at least 3 wt %, or at least 5 wt % of anti-blocking agent.

In one embodiment, the film is substantially free of antiblock agents. Substantially free of antiblock agents is defined to mean that an antiblock agent has not deliberately been added to the film composition, or, in the alternative, if present the film composition comprises less than 3 wt % of antiblock, or more preferably less than 1 wt % of antiblock, or most preferably less than 0.5 wt % of antiblock, or even more preferably, less than 0.1 wt % of antiblock. In another embodiment, the film is substantially free of talc, and the film comprises less than 3 wt % of talc, or less than 1 wt % of talc, or less than 0.5 wt % of talc, or less than 0.1 wt % of talc.

The antiblock can be added to the composition in neat form, diluted, and/or as a masterbatch in, for example, polyolefinic polymers, such as polypropylene, polystyrene, low density polyethylene, high density polyethylene, or propylene-alpha-olefin copolymers.

### Film Composition

The film may be a monolayer film or a multilayer film. At least one of the outermost layers of the film comprises the propylene-alpha-olefin copolymer, a first modifier, and a second modifier. The first modifier comprises a first unsaturated amide-containing slip agent. The second modifier is selected from: i) a second unsaturated amide-containing slip agent, which may be the same or different than the first amide-containing slip agent, ii) a saturated amide-containing slip-agent; iii) an antiblock; and iv) a mixture of any two or more of i, ii, and iii.

In one embodiment, the second modifier may consist essentially of the second unsaturated amide-containing slip agent and the saturated amide-containing slip-agent. In another embodiment, the second modifier may consist essentially of the saturated amide-containing slip agent.

The layer may comprise the first modifier in an amount greater than or equal to 0.05 wt %, or greater than or equal to 0.10 wt %, or greater than or equal to 0.25 wt %, or greater than or equal to 0.50 wt %, or greater than or equal to 0.75 wt %, or greater than or equal to 1.0 wt %, based on the weight of the layer. In one embodiment, the first modifier may be present in the layer in an amount in the range of 0.05 wt % to 20 wt %, or in the range of 0.1 to 15 wt %, or in the range of 0.15 wt % to 10 wt %, or in the range of 0.25 to 9 wt %, or in the range of 0.50 to 8 wt %, or in the range of 0.75 to 7.0 wt %, or in the range of 1.0 to 5 wt %, based on the weight of the layer.

The layer may comprise the second modifier in an amount greater than or equal to 0.25 wt %, or greater than or equal to 0.50 wt %, or greater than or equal to 0.75 wt %, or greater than or equal to 1 wt %, or greater than or equal to 1.5 wt %, based on the weight of the layer. In one embodiment, the second modifier may be present in the layer in an amount in the range of 0.25 wt % to 20 wt %, or in the range of 0.25 wt % to 15 wt %, or in the range of 0.50 wt % to 13 wt %, or in the range of 0.75 wt % to 10 wt %, or in the range of 1.0 wt % to 8 wt %, or in the range of 1.5 wt % to 7 wt % or in the range of 1.75 wt % to 5 wt %, based on the weight of the layer.

The film may have a coefficient of friction of less than or equal to 1.0, or less than or equal to 0.9, or less than or equal to 0.80, or less than or equal to 0.75, or less than or equal to 0.50, or less than or equal to 0.40, or less than or equal to 0.30.

In some embodiments, the film may have a haze of less than 25%, or less than 23%, or less than 22%, or less than 20%, or less than 15%, or less than 10%, or less than 8%, or less than 5%. The film may have a haze in the range of 0.1% to 25%, or in the range of 1% to 15%, or in the range of 1.5% to 10%.

In a one embodiment, the propylene-alpha-olefin copolymer consists essentially of propylene and ethylene derived units. When the copolymer is in one of the outermost layers of the film, the higher the ethylene-comonomer content in the copolymer, the tackier the film may become. Varying the amount of the first and second modifiers and varying the content of the second modifier may allow for tailoring of the coefficient of friction and the tackiness of the film.

In one embodiment, at least one of the outermost layers of the film comprises a propylene-alpha-olefin copolymer comprising at least 10 wt % of ethylene-derived units, or from 10 to 12 wt % of ethylene-derived units, based on the total weight of the copolymer. In such an embodiment, the layer may comprise a second-modifier comprising: a) greater than or equal to 0.25 wt % of the second unsaturated amide-containing slip agent, and b) greater than or equal to 0.50 wt %, or greater than or equal to 0.75 wt %, or greater than or equal to 1.0 wt %, of a saturated amide-containing slip agent, based on the weight of the layer. Alternatively, the layer may comprise a second-modifier which consists essentially of: a) greater than or equal to 0.25 wt % of the second unsaturated amide-containing slip agent, and b) greater than or equal to 0.50 wt %, or greater than or equal to 0.75 wt %, or greater than or equal to 1.0 wt %, or greater than or equal to 2.0 wt %, of a saturated amide-containing slip agent, based on the weight of the layer. Alternatively, the layer may comprise a second-modifier which consists essentially of greater than or equal to 0.50 wt %, or greater than or equal to 0.75 wt %, or greater than or equal to 1.0 wt %, of a saturated amide-containing slip agent, based on the weight of the layer. Alternatively, the layer may comprise a second modifier comprising: a) greater than or equal to 0.25 wt % of the second unsaturated amide-containing slip agent, and b) greater than or equal to 0.5 wt %, or greater than or equal to 1.0 wt %, or greater than or equal to 1.5 wt %, or greater than or equal to 2 wt % of antiblock. In such embodiments, the film may have a coefficient of friction (“COF”) of less than or equal to 0.5, or less than or equal to 0.4, or less than or equal to 0.3, or less than or equal to 0.2.

In another embodiment, at least one of the outermost layers of the film comprises a propylene-alpha-olefin copolymer comprising at least 15 wt % of ethylene-derived units, or from 15 to 20 wt % of ethylene-derived units. In such an embodiment, the layer may comprise a second modifier comprising: a) greater than or equal to 0.25 wt % of a second unsaturated amide-containing slip-agent, b) greater than or equal to 0.25 wt %, or greater than or equal to 0.50 wt %, of a saturated amide-containing slip agent, and c) greater than or equal to 0.25 wt %, or greater than or equal to 0.50 wt %, of antiblock. Alternatively, the layer may comprise a second modifier comprising: a) greater than or equal to 0.25 wt % of a second unsaturated amide-containing slip agent, b) greater than or equal to 1.0 wt %, or greater than or equal to 2.0 wt %, or greater than or equal to 3.0 wt %, of anti-block. Alternatively, the layer may comprise a second modifier comprising: a) greater than or equal to 0.25 wt % of a second unsaturated amide-containing slip agent, and b) greater than or equal to 1.0 wt %, or greater than or equal to 2.0 wt %, or greater than or equal to 3.0 wt %, of a saturated amide-containing slip agent. Alternatively, the layer may comprise a second modifier which consists essentially of: a) greater than or equal to 0.25 wt % of a second unsaturated amide-containing slip agent, and b) greater than or equal to 1.0 wt %, or greater than or equal to 2.0 wt %, or greater than or equal to 3.0 wt %, of a saturated amide-containing slip agent. Alternatively, the layer may comprise a second modifier which consists essentially of greater than or equal to 1.0 wt %, or greater than or equal to 2.0 wt %, or greater than or equal to 3.0 wt %, of a saturated amide-containing slip agent. In such embodiments, the film may have a coefficient of friction (“COF”) of less than 0.5, or less than 0.4, or less than 0.3, or less than 0.2.

The film may further comprise one or more additives in one or more layers of the film. Examples of useful additives include, but are not limited to, opacifying agents, pigments, colorants, cavitating agents, antioxidants, anti-fog agents, anti-static agents, moisture barrier additives, gas barrier additives, hydrocarbon resins, hydrocarbon waxes, fillers such as calcium carbonate, diatomaceous earth and carbon black, and combinations thereof. Such additives may be used in effective amounts, which vary depending upon the property required.

In one embodiment, at least one of the outermost layers of the film comprises 25 wt % of the propylene-alpha-olefin copolymer based on the total weight of the layer, or greater than or equal to 30 wt % of copolymer, or preferably greater than or equal to 50 wt % of copolymer, or in some embodiments, greater than or equal to 75 wt % of the copolymer, or greater than or equal to 80 wt % of the copolymer, or greater than or equal to 90 wt % of the copolymer, or greater than or equal to 95 wt % of the copolymer. In another embodiment, the at least one of the outermost layers of the film comprises propylene-alpha-olefin copolymers in an amount ranging from 50 wt % to 100 wt % based on the total weight of the layer, or in the range of 60 wt % to 99 wt %, or in the range of 70 wt % to 95 wt %, or in the range of 75 wt % to 90 wt %.

The film may comprise one or more layers containing one or more film-forming polyolefins. In one embodiment, in addition to comprising a propylene-alpha-olefin copolymer, the outermost layer of the film may further comprise one or more film-forming polyolefins. The film-forming polyolefins may be selected from propylene, ethylene, polypropylene, isotactic polypropylene (“iPP”), high crystallinity polypropylene (“HCPP”), ethylene-propylene copolymers, ethylene propylene random copolymer, ethylene-propylene block copolymers, propylene-butene copolymers, ethylene-propylene-butylene terpolymers, high density polyethylene (“HDPE”), medium density polyethylene (“MDPE”), low density polyethylene (“LDPE”), linear low density polyethylene (“LLDPE”), syndiotactic polypropylene (sPP), EVA, and combinations thereof. The polymers may be produced by Ziegler-Natta catalyst, metallocene catalyst, or any other suitable means.

In one embodiment, the film-forming polyolefin comprises a LDPE having a density of about 0.926 g/cm³ or less and a melt index (“MI”) of about 7 g/10 min. The MI may be determined by ASTM D1238.

In another embodiment, the film-forming polyolefin comprises a LLDPE having a density in the range of about 0.90 g/cm³ to about 0.94 g/cm³, or more preferably in the range of about 0.910 g/cm³ to about 0.926 g/cm³. The LLDPE may have a melt index in the range of about 1 to about 10 g/10 min, or in the range of 0.5 to 10 g/10 min. The LLDPE may be a copolymer of ethylene and a minor amount of a higher olefin comonomer containing 4 to 10 carbon atoms, such as for example, butene-1, hexene-1, or octene-1.

In yet another embodiment, the film-forming polyolefin comprises a MDPE having a density in the range of about 0.926 to about 0.940 g/cm³.

In a further embodiment, the film-forming polyolefin comprises a HDPE. HDPE is a substantially linear polyolefin having a density of about 0.940 g/cm³ or more, or preferably 0.952 g/cm³ or more. The HDPE may have a density in the range of about 0.952 g/cm³ to about 0.962 g/cm³. The HDPE may have a MI in the range of about 0.2 to about 10.0 g/10 min, or preferably in the range of about 0.5 to about 2.0 g/10 min, and a melting point of in the range of about 130° C. to about 148° C.

The film-forming polyolefin may comprise a syndiotactic polypropylene (“sPP”) having an isotacticity of less than 25%, or less than 15%, or less than 6%. The mean length of the syndiotactic sequences may be greater than 20, or greater than 25.

The film-forming polyolefin may be an iPP which has an isotacticity in the range of about 93% to about 99%, a crystallinity in the range of about 70% to about 80%, and a melting point in the range of about 145° C. to about 167° C.

### Making the Film

The film may be a cast film or a blown film. In one embodiment the film is formed by melt blending a propylene-alpha-olefin copolymer and an additive masterbatch, extruding the melt through one or more extruder dies, and forming a blown or cast film. In a preferred embodiment, the melt blend forms at least one of the outermost layers of the film. The additive masterbatch comprises a polymer carrier, a first modifier in an amount greater than or equal to 0.10 wt %, and a second modifier in an amount greater than or equal to 0.50 wt %, based on the weight of melt blend. The polymer carrier may be a polyolefin polymer, such as, polypropylene, polystyrene, low density polyethylene, high density polyethylene, or a propylene-alpha-olefin copolymer. The first modifier comprises a first unsaturated amide-containing slip agent. The second modifier is selected from: i) a second unsaturated amide-containing slip agent, which may be the same or different than the first amide-containing slip agent, ii) a saturated amide-containing slip-agent; iii) an antiblock; and iv) a mixture of any two or more of i, ii, and iii.

In another embodiment, the additive masterbatch may comprise: a) a polymer carrier in an amount greater than or equal to 30 wt %, or greater than or equal to 40 wt %, or greater than or equal to 50 wt %, or greater than or equal to 60 wt %; b) a first modifier in an amount greater than or equal to 3 wt %, or greater than or equal to 5 wt %, or greater than or equal to 10 wt %, or greater than or equal to 15 wt %, or greater than or equal to 20 wt %; and c) a second modifier in an amount greater than or equal to 3 wt %, or greater than or equal to 5 wt %, or greater than or equal to 10 wt %, or greater than or equal to 15 wt %, or greater than or equal to 20 wt %, based on the weight of the additive masterbatch. In one embodiment, the additive masterbatch comprises greater than or equal to 50 wt % of polymer carrier, greater than or equal to 3 wt % of the first modifier, and greater than or equal to 25 wt % of the second modifier, based on the weight of the additive masterbatch. In another embodiment, the additive masterbatch comprises greater than or equal to 75 wt % of polymer carrier, greater than or equal to 0.1 wt % of the first modifier, and greater than or equal to 3 wt % of the second modifier, based on the weight of the additive masterbatch. In another embodiment, the additive masterbatch comprises greater than or equal to 90% of the polymer carrier, greater than or equal to 0.1 wt % of the first modifier, and greater than or equal to 3 wt % of the second modifier, based on the weight of the additive masterbatch.

In another embodiment, the additive masterbatch may comprise: a) a polymer carrier in an amount in the range of 50 to 99.9 wt %, or in the range of 65 to 95 wt %; b) a first modifier in an amount in the range of 0.05 to 20 wt %, or in the range of 0.1 to 15 wt %; and c) a second modifier in an amount in the range of 0.05 to 30 wt %, or in the range of 0.1 to 20 wt %, based on the weight of the additive masterbatch.

The components that make up the film layer may be melt-blended either in the same melt-blending means used in the film-making process, or separately. For example, in one embodiment, the components of the additive masterbatch may be melt blended together, pelletized, and then the pelletized additive masterbatch may be melt blended with the propylene-alpha-olefin copolymer, which may or may not have been previously pelletized. In another embodiment, the components are combined in a melt-blending means separately from those being used in the film-making process. In a particular embodiment, the components are combined in an extruder or high intensity mixer, or a twin screw extruder in one embodiment. A shear force and/or other heating means, if necessary, are applied to the components within the extruder to bring the temperature of the melt to at least the melting point of the highest melting component, and to at least 160° C., or 180° C., or 200° C., or 220° C., or 230° C. in some embodiments.

To make the films, any process that is known in the art can be used such as film-blowing, tenter processes, and casting; the films may also be used in extrusion coating and thermoforming.

In one embodiment, the film is a blown-film. Three layers of composition may be extruded to form a three layer film. In certain embodiments, a collapsed bubble forms the final film in which one layer, an “inner skin” and core or “middle” layer are combined into a thick new layer. The outer skin layer of the blown film bubble preferably comprises the propylene-alpha-olefin copolymer, the first modifier, and the second modifer, and constitutes the skin layers of the final film. The blow up ratio (“BUR”) for the blown films can be within a range of from 1 to 10 in one embodiment, and from 1.5 to 8 in another embodiment, and from 1.8 to 5 in yet another embodiment, and from 2.0 to 3.5 in another embodiment; and the die gap can be within a range of from 0.5 to 9 mm in one embodiment, and from 0.8 to 5 mm in another embodiment, and from 1.0 to 2.0 mm in yet another embodiment.

In another embodiment, the film is a cast film. The cast film may be formed by extruding at least one layer comprising the propylene-alpha-olefin copolymer, the first modifier, and the second modifier. The film may also be formed by co-extruding: a) a core layer comprising one or more film-forming polyolefins, b) optionally, one or more tie layers comprising one or more film-forming polyolefins, c) at least one skin layer which comprises the propylene-alpha-olefin copolymer, the first modifier, and the second modifier, and d) optionally, another skin layer which comprises one or more film-forming polyolefins. The layers may be extruded together with any additional layers through a flat sheet extruder die at a temperature in the range of between 200° C. to 260° C., then the co-extruded layers may be cast onto a cooling drum and the film may be quenched. The sheet may then be stretched from 3 to 7 times its original size, in the machine direction (MD) orienter, followed by stretching from 5 to 10 times its original size in the transverse direction (TD) orienter. The film may then wound onto a reel.

The films can be derived from one, two, three or more layers. In one embodiment, each layer is extruded separately, then combined to form one film structure. In other embodiments, the layers may be co-extruded. Suitable film structures include, for example, “ABA,” wherein a film having the “ABA” structure has three layers, a middle layer made from “B,” and outer “A” layers on either face of “B.” Non-limiting examples of other structures include “A” only, “B” only, AB, BAB, ABA, AAB, AABAA, BABB, BBAB, BBAABB, ABABA, BABAB, AABBBA, and other variants comprising from 2 or 3 to 5 or 6 or 7 or 8 or more layers. In a particular embodiment, there are three extrudates having an ABA configuration; wherein at least one of the A layers comprise the propylene-alpha-olefin copolymer, the first modifier, and the second modifier.

The films can have any number of layers in any ratio of thicknesses. In a one embodiment, a three layer film is produced having an outer skin layer, a middle layer, and an inner skin layer in a ratio within a range of from 1/1/1 to 1/20/1 in one embodiment, or in the range of 1/2/1 to 1/15/1, or in the range of 1/3/1 to 1/10/1. Each layer can be any desirable thickness, and may be in the range of 1 to 100 μm in one embodiment, or in the range of 2 to 80 μm, or in the range of 3 to 40 μm, or in the range of 4 to 15 μm. Given the variety of film structures as mentioned above (e.g., ABA, AAB, AABAA, etc.), the total film thickness can vary greatly. In one embodiment the total film thickness or “film thickness” is in the range of 10 to 500 μm, or in the range of 20 to 400 μm, or in the range of 30 to 300 μm, or in the range of 40 to 200 μm, or in the range of 50 to 150 μm. Of course, a desirable thickness range of the layers and film can comprise any combination of an upper limit with any lower limit as described herein.

In some embodiments, the film may be useful as flexible packaging film to package an article or good, such as a food item or other product. In some applications, the film may be formed into a pouch type of package, such as may be useful for packaging a beverage, liquid, granular, or dry-powder product. In other embodiments, the film may be useful in elastic apparel, such as elastic seam tape, hygiene products, or diapers.

### Test Methods

Techniques for determining the molecular weight (Mn, Mw, and Mz) and MWD are as follows, and as in Verstate et al, in 21 MACROMOLECULES 3360 (1988). Conditions described herein govern over published test conditions. Molecular weight and MWD are measured using a Waters 150 gel permeation chromatograph equipped with a Chromatix KMX-6 on-line light scattering photometer. The system is used at 135° C. with 1,2,4-trichlorobenze as the mobile phase. Showdex (Showa-Denko America, Inc.) polystyrene gel columns 802, 803, 804, and 805 are used. This technique is discussed in LIQUID CHROMATOGRAPHY OF POLYMERS AND RELATED MATERIALS III 207 (J. Cazes ed., Marcel Dekker, 1981). No corrections for column spreading were employed; however, data on generally acceptable standards, e.g., National Bureau of Standards Polyethylene 1484 and anionically produced hydrogenated polyisoprenes (an alternating ethylenepropylene copolymer) demonstrate that such corrections on Mw/Mn or Mz/Mw are less than 0.05 units. Mw/Mn was calculated from an elution time-molecular relationship whereas Mz/Mw was evaluated using the light scattering photometer. The numerical analysis can be performed using the commercially available computer software GPC2, MOLWT2 available from LDC/Milton Roy-Rivera Beach, Fla.

The procedure for DSC determinations is as follows. About 0.5 grams of polymer is weighed and pressed to a thickness of about 15 to 20 mils (about 381-508 microns) at about 140-150° C., using a “DSC mold” and MYLAR™ film as a backing sheet. The pressed polymer sample is allowed to cool to ambient temperatures by hanging in air (the MYLAR™ film backing sheet is not removed). The pressed polymer sample is then annealed at room temperature (about 23-25° C.) for about 8 days. At the end of this period, a 15-20 mg disc is removed from the pressed polymer sample using a punch die and is placed in a 10 microliter aluminum sample pan. The disc sample is then placed in a DSC (Perkin Elmer Pyris 1 Thermal Analysis System) and is cooled to about −100° C. The sample is heated at about 10° C./min to attain a final temperature of about 165° C. The thermal output, recorded as the area under the melting peak of the disc sample, is a measure of the heat of fusion and can be expressed in Joules per gram (J/g) of polymer and is automatically calculated by the Perkin Elmer system. Under theses conditions, the melting profile shows two (2) maxims, the maxima at the highest temperature is taken as the melting point within the range of melting of the disc sample relative to a baseline measurement for the increasing heat capacity of the polymer as a function of temperature.

Triad tacticity is determined as follows: The tacticity index, expressed herein as “m/r”, is determined by ¹³C nuclear magnetic resonance (“NMR”). The tacticity index m/r is calculated as defined by H. N. Cheng in 17 MACROMOLECULES 1950 (1984), incorporated herein by reference. The designation “m” or “r” describes the stereochemistry of pairs of contiguous propylene groups, with “m” referring to messo and “r” referring to racemic. An m/r ratio of 1.0 generally describes a syndiotactic polymer, and an m/r ratio of 2.0 generally describes an atactic material. An isotactic material theoretically may have a m/r ratio approaching infinity, and many by-product atactic polymer have sufficient isotactic content to result in an m/r ratio of greater than 50. Embodiments of the propylene-α-olefin copolymer may have a tacticity index m/r ranging from a lower limit of 4 or 6 to an upper limit of 8 or 10 or 12.

The elongation at break, tensile strength at break, and 1% secant modulus were determined according to a test method based on ASTM D-882 using an INSTRON™ testing machine.

Static and kinetic coefficients of friction (COF) were determined substantially in accordance with ASTM D1894. The COF of film against film was measured with a 200 g weight at 150 mm/min for 150 mm length.

The melt index (I₂) was determined according to ASTM D1238.

Haze was determined according to ASTM D1003.

Elemendorf Tear was determined according to a test method based on ASTM D11922-06a.

The film's gloss at 450 may be determined by ASTM D-2457.

The thickness (i.e., guage) of the film and the thickness of the film's layers may be measured using an optical gauge, such as Model # 283-20 available from Beta LaserMike, Dayton, Ohio.

The puncture force and puncture energy at break are measured with an INSTRON™ testing machine, following an internal ExxonMobil test method. A piston with a standard probe fixed to the load cell is pushed through a film sample in a circular sample holder up to break. The probe is hemispherical and made of stainless steel (high polish); probe diameter is 20 mm. Testing speed is 500 mm/min. Reported are force and energy at break. Full Break: This is the force at the breakpoint of the film sample (when the probe has fully penetrated the film sample) and is expressed in Newtons or normalized for film sample thickness (N/mm or N/μm). Energy to break: This is the area under the force-displacement curve (integration) at the breakpoint and is expressed in mJ or normalized for film sample thickness (mJ/μm).

The reblock test (Reblock @ RT (I/I)) measures the degree of blocking (i.e., adhesion) which can exist between layers of film. The degree of blocking is expressed as the grams of force required to separate two parallel plates which have been wrapped with the film sample. Initial blocking force may be measured according to ASTM D-3354. In the Examples the induced blocking was measured with a Kayness Block-Reblock Tester. Unless otherwise specified, the films tested were conditioned at least 16 hours at 23±2° C. and 50±5% relative humidity prior to cutting samples. The test samples were cut at least 24 hours before testing, placed between 4-inch×7-inch (10.16 cm×17.78 cm) pieces of stiff, plain paper, and laid out undisturbed until testing. The film samples were die cut to a dimension of 4-inch×7-inch (10.16 cm×17.78 cm) with the 7-inch (17.78 cm) dimension being in the machine direction. Five (5) pairs of specimens were cut from each film sample being tested.

### EXAMPLES

The propylene-alpha-olefin copolymer based films will now be further described with reference to the following non-limiting examples. A listing of various components used in the Examples is in Table 1.

TABLE 1
Various Components Used in the Examples

| Component | Brief Description | Commercial Source |
|---|---|---|
| ABT ™ 2500 Talc | Talc | Specialty Minerals Inc. |
| ALTUGLAS ™ BS130 | PMMA | Altuglas International |
| ALTUGLAS ™ VM100 | PMMA | Altuglas International |
| Arnite T04-202 | PBT | DSM |
| Erucamide | Crodamide ™ ER | Croda Universal Inc., USA |
| IRGANOX ™ 1010 | Phenolic based anti-oxidant. | Ciba Specialty Chemicals |
| Oleamide | Crodamide ™ VRX. | Croda Universal Inc., USA |
| PEG MB | Masterbatch of PEG 400 | N/A |
| | (CARBOWAX ™ 400) and | |
| | PEG 6000 | |
| | (CARBOWAX ™ 6000), | |
| | both available from Dow | |
| | Chemical Company. | |
| PEG8000 | Polyethylene glycol. | Promega |
| PP3546G (“HFPP”) | High melt flow rate | ExxonMobil Chemical Company |
| | polypropylene | |
| | homopolymer (MFR = 1200 g/ | |
| | 10 min, ASTM D1238 at | |
| | 230° C., 2.16 kg). | |
| PP3563F2 (“PP”) | Propylene homopolymer. | ExxonMobil Chemical Company |
| Stearamide | | Croda Universal Inc. |
| ULTRAMID ™ B3 | Polyamide (nylon 6). | BASF |
| (“PA”) | | |
| VISTAMAXX ™ 3000 | Propylene-ethylene | ExxonMobil Chemical Company |
| elastomer resin. | copolymer with 11 wt % | |
| (“VMX3000”) | ethylene content; | |
| | density = 0.871 g/cm³; Vicat | |
| | Softening Point = 64° C. | |
| | (ASTM D1525, 200 g). | |
| VISTAMAXX ™ 6102 | Propylene-ethylene | ExxonMobil Chemical Company |
| elastomer resin. | copolymer with 16 wt % | |
| (“VMX6102”) | ethylene content; | |
| | density = 0.862 g/cm³; Vicat | |
| | Softening Point = 59° C. | |
| | (ASTM D1525, 200 g). | |
| VMX MB | 65 wt % VMX3000, 30% | N/A |
| | Sicron M4000 silica & 5% | |
| | Crodamide VRX oleamide | |

### Example 1

In Example 1, cast films were made with propylene-ethylene copolymers having either 11 wt % (VMX3000) or 16 wt % (VMX6102) ethylene content. The films also contained varying amounts of additives, slip agents, and antiblock. The films were tested for coefficient of friction and haze, with the results in Table 2.

TABLE 2
Example 1 Film Compositions and COF Properties

| | Propylene- | | Slip | | | | Haze ± |
|---|---|---|---|---|---|---|---|
| | α-Olefin | Additives | Agent | Antiblock | Static | Kinetic | SD |
| Film | Copolymer | [wt %] | [ppm] | [wt %] | COF ± SD | COF ± SD | [%] |
| 1 | VMX3000 | 10% PP + | 500 | 0.3 | 3.00 ± 0.65 | 1.75 ± 1.22 | 2.6 ± 0.1 |
| | | 1% VMX MB | | | | | |
| 2 | VMX3000 | 3% PP + | 500 | 0.3 | 3.29 ± 0.88 | 2.44 ± 0.48 | 2.8 ± 0.1 |
| | | 1% VMX MB | | | | | |
| 3 | VMX3000 | 1% PP + | 500 | 0.3 | 2.80 ± 0.07 | 2.07 ± 0.26 | 2.9 ± 0.1 |
| | | 1% VMX MB | | | | | |
| 4 | VMX3000 | 10% VMX MB | 5000 | 3 | 0.15 ± 0.01 | 0.13 ± 0.00 | 7.9 ± 0.3 |
| 5 | VMX3000 | 5% VMX MB | 2500 | 1.5 | 0.19 ± 0.02 | 0.15 ± 0.01 | 5.3 ± 0.5 |
| 6 | VMX6102 | 20% VMX MB | 10000 | 6 | 0.27 ± 0.07 | 0.24 ± 0.05 | 22.9 ± 0.4 |
| 7 | VMX6102 | 10% PP + | 500 | 0.3 | Too sticky | — | 2.4 ± 0.1 |
| | | 1% VMX MB | | | | | |
| 8 | VMX6102 | 10% PEG MB | 0 | 1 | — | — | — |
| 9 | VMX6102 | 1% PEG8000 | 0 | 1 | — | — | — |
| 10 | VMX6102 | 10% PEG 8000 | 0 | 1 | — | — | — |
| 11 | VMX6102 | 10% | 0 | 0 | Too sticky | — | 13.7 ± 0.7 |
| | | AltuglasVM100 | | | | | |
| 12 | VMX6102 | 10% | 0 | 10 | — | — | — |
| | | AltuglasBS130 | | | | | |
| 13 | VMX6102 | 10% PA | 0 | 0 | Too sticky | — | 61.2 ± 3.4 |
| 14 | VMX6102 | 10% PBT | 0 | 0 | Too sticky | — | 91.2 ± 0.9 |
| 15 | VMX6102 | 10% HFPP | 0 | 0 | — | — | — |

Adding polypropylene homopolymer or antiblock particulates alone, gave insufficient slip and antiblock properties. However, when slip additives, such as oleamide and erucamide, were used in conjunction with antiblock particulates, the films had a measurable COF. Films 4 and 5 had a COF of less than about 0.30 while maintaining good clarity. By adjusting the amount of slip additives and antiblock particulates in the film the COF of the film was tailored.

The films containing VMX3000 (Films 1-5) were formulated for low COF and low antiblocking tendency. In the films containing VMX3000, amide levels between 2500 ppm and 10000 ppm combined with at least 1.5% antiblock, were needed to formulate for low blocking and measurablely low COF values. Film 5 had a 0.19 COF, when 2500 ppm oleamide and 1.5 wt % antiblock were used in the 100 μm film.

In the films containing VMX6102, 10000 ppm of oleamide combined with antiblock (±6 wt %) was needed to give a very good COF value of about 0.25. It is believed that larger amounts of slip additives and antiblock were needed due to the higher ethylene content in VMX6102, as compared to VMX3000.

### Example 2

In Example 2, cast films were made with propylene-ethylene copolymers having 16 wt % ethylene content. The films also contained varying amounts of erucamide, oleamide, and/or stearamide, as well as talc and/or phenolic primary antioxidant resins.

The films were produced on a 1-inch (2.54 cm) KILLION™ cast line equipped with a 10-inch (25.4 cm) slit die. The VISTAMAXX™ resins and additives were pre-compounded using a 30 mm twin-screw extruder with melt temperature approximately 330° F. (165.6° C.) followed by pelletization. Pre-compounded pellets were then fed into the KILLION™ cast extruder and converted into a film of approximately 5-mil in thickness. The cast extruder was operated within a temperature range of approximately 275° F. (135° C.) near the feed zone to approximately 475° F. (246.1° C.) at the die/feedblock. Exiting the cast die, the melt extrudate was immediately quenched by a highly polished cast roll controlled to a temperature of approximately 55° F. (12.8° C.). From the cast roll, the quenched film was then wound onto a 2-inch (5.08 cm) core under tension control and placed in a controlled lab for conditioning.

The films were tested for blocking on the roll by qualitative measure. Following film aging at room temperature on the roll, the films were unwound by hand from the roll. If the films could not be unwound at all or unwound without tearing or significant modification of the film from its original form, it was concluded that the film was “blocked.” If the film was easily unwound from the roll without significant film sticking, tearing, or elongation, or modification from its original form it was concluded that the film did not block on the roll. In instances when some film sticking upon unwinding by hand was seen, but under some hand tension the film was unwound from the roll without film tearing or significant extension, the film was deemed as a “partial” blocked roll. Films that were qualitatively measured not to block were then validated in the lab by re-block testing.

Table 3 lists the film compositions and the results of the blocking test. Films 7, 16, 21, and 25 were further tested for a variety of physical properties, with the results shown in Table 4.

TABLE 3
Example 2 Film Compositions and Blocking Properties

| | | | | | ABT | | |
|---|---|---|---|---|---|---|---|
| | | | | | 2500 | | Blocked |
| | VMX6102 | Erucamide | Oleamide | Stearamide | Talc | IRGANOX ™ | (Yes or |
| Film | [wt %] | [wt %] | [wt %] | [wt %] | [wt %] | 1010 [wt %] | No) |
| 1 | 99.00% | 0.50% | — | — | 0.50% | 0.10% | Yes |
| 2 | 99.00% | — | — | 0.50% | 0.50% | 0.10% | Yes |
| 3 | 99.00% | 0.50% | 0.50% | — | — | 0.10% | Partial |
| 4 | 97.50% | 1.00% | — | — | 1.50% | 0.10% | Yes |
| 5 | 99.00% | 0.50% | 0.50% | — | — | 0.10% | Partial |
| 6 | 97.50% | — | 1.00% | — | 1.50% | 0.10% | Yes |
| 7 | 99.00% | 0.50% | — | 0.50% | — | 0.10% | No |
| 8 | 99.00% | 1.00% | — | — | — | 0.10% | Yes |
| 9 | 96.00% | — | 1.00% | — | 3.00% | 0.10% | Yes |
| 10 | 99.00% | — | — | — | 1.00% | 0.10% | Yes |
| 11 | 99.00% | — | — | 0.50% | 0.50% | 0.10% | Yes |
| 12 | 99.00% | — | — | — | 1.00% | 0.10% | Yes |
| 13 | 96.00% | — | 0.50% | — | 3.50% | 0.10% | Yes |
| 14 | 96.00% | — | — | — | 4.00% | 0.10% | Yes |
| 15 | 97.50% | — | — | 1.00% | 1.50% | 0.10% | Yes |
| 16 | 99.00% | — | 0.50% | 0.50% | — | 0.10% | No |
| 17 | 97.50% | 0.13% | 0.13% | 0.13% | 2.13% | 0.10% | Yes |
| 18 | 96.00% | — | — | 1.00% | 3.00% | 0.10% | Yes |
| 19 | 96.00% | 1.00% | — | — | 3.00% | 0.10% | Yes |
| 20 | 99.00% | — | 1.00% | — | — | 0.10% | Yes |
| 21 | 99.00% | — | 0.50% | 0.50% | — | 0.10% | No |
| 22 | 98.25% | 0.13% | 0.63% | 0.13% | 0.88% | 0.10% | Yes |
| 23 | 96.75% | 0.13% | 0.13% | 0.13% | 2.88% | 0.10% | Yes |
| 24 | 99.00% | 0.50% | — | 0.50% | — | 0.10% | No |
| 25 | 99.00% | — | — | 1.00% | — | 0.10% | No |

TABLE 4
Film Properties of Select Films From Table 3

| | Film 7 | Film 16 | Film 21 | Film 25 |
|---|---|---|---|---|
| Tensile Test | | | | |
| Yield Strength (psi) | | | | |
| MD Yield | 128 | 124 | 149 | 137 |
| TD Yield | 145 | 140 | 136 | 136 |
| Elongation @ Yield (%) | | | | |
| MD Elongation | 11.2 | 10.6 | 15.0 | 12.9 |
| TD Elongation | 14.5 | 13.6 | 12.8 | 11.4 |
| Tensile Strength (psi) | | | | |
| MD Tensile | 2438 | 1553 | 2168 | 1618 |
| TD Tensile | 1557 | 1816 | 1610 | 1702 |
| Elongation @ Break (%) | | | | |
| MD Elongation | 910 | 807 | 849 | 783 |
| TD Elongation | 842 | 884 | 834 | 852 |
| 1% Secant (psi) | | | | |
| MD Secant | 1446 | 1533 | 1423 | 1480 |
| TD Secant | 1498 | 1567 | 1482 | 1565 |
| Elemendorf Tear | | | | |
| MD Tear (grams) | 334.32 | 340.80 | 250.80 | 181.20 |
| MD Tear (g/mil) | 55.35 | 67.62 | 49.18 | 35.39 |
| TD Tear (grams) | 353.44 | 406.32 | 274.96 | 197.76 |
| TD Tear (g/mil) | 58.04 | 82.08 | 55.21 | 37.89 |
| Haze (%) | 2.8 | 5.1 | 2.9 | 5.3 |
| Gloss @ 45° | | | | |
| MD | 81 | 78 | 79 | 73 |
| TD | 80 | 76 | 77 | 76 |
| Gauge (mil) | | | | |
| Average | 5.90 | 5.10 | 5.09 | 5.07 |
| Low | 5.34 | 6.67 | 4.37 | 4.64 |
| High | 6.75 | 4.29 | 5.83 | 5.44 |
| Puncture Method A | | | | |
| Peak Load (lbs) | 23.49 | 20.15 | 19.06 | 27.56 |
| Peak/mil (lb/mil) | 3.98 | 3.95 | 3.74 | 5.44 |
| Break Energy (in-lb) | 110.73 | 96.36 | 91.19 | 115.49 |
| Break Energy/mil (in-lb/mil) | 18.77 | 18.89 | 17.92 | 22.78 |
| Reblock @ RT (I/I) | | | | |
| grams | 152.3* | 106.1** | 102.3 | 125.3* |

*For Films 7 and 25 - all 5 specimens did not separate.
**For film 16 - only one specimen out of did not separate.

Films 3, 5, 7, 16, 21, 24, and 25 either did not block at all or only exhibited partial blocking. A combination of unsaturated amides (e.g., erucamide or oleamide) and saturated amides (e.g., behenamide or stearamide) was effective when used in the film to reduce and/or eliminate blocking. These films exhibited only partial blocking or no blocking at all, even though no antiblock mineral filler (e.g., talc) was used. Film compositions #16 and 21 showed the best antiblocking tendency and optical properties (low haze). The reblock measurements shown in Table 5 confirm the antiblocking tendencies of films #16 and #21.

All patents and patent applications, test procedures (such as ASTM methods, UL methods, and the like), and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The invention has been described above with reference to numerous embodiments and specific examples. Many variations will suggest themselves to those skilled in this art in light of the above detailed description. All such obvious variations are within the full intended scope of the appended claims.

What is claimed is:

1. A film comprising at least one layer, said layer comprising:
a) a propylene-alpha-olefin copolymer,
comprising propylene-derived units and from 5 to 35 wt %, based on the weight of said copolymer, of units derived from ethylene and/or C4 to C10 alpha-olefins, and
having a melt flow rate, as determined by ASTM D1238 at 23° C., in the range of 0.5 to 50 dg/min and a heat of fusion (Hf) of less than 75 J/g;
b) a first modifier, comprising a first unsaturated amide-containing slip agent; and
c) a second modifier selected from:
i. a second unsaturated amide-containing slip agent, which may be the same or different than said first unsaturated amide-containing slip-agent;
ii. a saturated amide-containing slip agent;
iii. an antiblock; and
iv. a mixture of any two or more of i, ii, and iii;
wherein said first modifier is present in an amount greater than or equal to 0.10 wt % and said second modifier is present in an amount greater than or equal to 0.50 wt %, both based on the weight of said layer; and
wherein the film has a coefficient of friction of less than or equal to 0.80.

2. The film of claim 1, wherein said layer comprises greater than or equal to 50 wt % of said copolymer.

3. The film of claim 1, wherein said copolymer consists essentially of units derived from propylene and ethylene.

4. The film of claim 3, wherein said copolymer comprises from 10 to 12 wt % of ethylene-derived units based on the total weight of said copolymer.

5. The film of claim 4, wherein the layer comprises a second modifier comprising greater than or equal to 0.25 wt % of said second unsaturated amide-containing slip agent and greater than or equal to 0.50 wt % of said saturated amide-containing slip agent, both based on the weight of said layer.

6. The film of claim 4, wherein the layer comprises a second modifier consists essentially of greater than or equal to 0.25 wt % of the second unsaturated amide-containing slip agent and greater than or equal to 0.75 wt % of a saturated amide-containing slip agent, both based on the weight of the layer.

7. The film of claim 3, wherein said copolymer comprises from 15 to 20 wt % of units derived from ethylene based on the total weight of said copolymer.

8. The film of claim 7, wherein the layer comprises a second modifier comprising greater than or equal to 0.25 wt % of said second unsaturated amide-containing slip agent, greater than or equal to 0.25 wt % of said saturated amide-containing slip agent, and greater than or equal to 0.25 wt % of antiblock, based on the weight of said layer.

9. The film of claim 7, wherein the second modifier comprises greater than or equal to 0.25 wt % of said second unsaturated amide-containing slip agent, greater than or equal to 0.50 wt % of said saturated amide-containing slip agent, and greater than or equal to 0.5 wt % of antiblock.

10. The film of claim 1, wherein the first and second unsaturated amide-containing slip agents are the same or different and are selected from compounds having the formulas:
a) RCONH₂ wherein R is a C₅-C₂₃ alkene; and
b) (R′CO)₃₋ₓNR″ₓ, wherein
R′ is a C₁₀ to C₆₀ alkene radicals and substituted versions thereof,
R″ is selected from the group consisting of hydrogen atoms, C₁₀ to C₆₀ alkyl radicals and C₁₀ to C₆₀ alkene radicals, and substituted versions thereof, and
x is 0, 1, 2 or 3.

11. The film of claim 10, wherein the first and second unsaturated amide-containing slip agents are the same or different and are selected from the group consisting of palmitoleamide, oleamide, linoleamide, erucamide, and mixtures thereof.

12. The film of claim 10, wherein the first and second unsaturated amid-containing slip agents are the same or different and are oleamide, erucamide, or mixtures thereof.

13. The film of claim 1, wherein the saturated amide-containing slip agent is selected from compounds having the formulas:
a) RCONH₂ wherein R is a C₅-C₂₃ alkyl; and
b) (R′CO)₃₋ₓNR″ₓ, wherein
R′ is a C₁₀ to C₆₀ alkyl radicals and substituted versions thereof;
R″ is selected from the group consisting of hydrogen atoms, C₁₀ to C₆₀ alkyl radicals and C₁₀ to C₆₀ alkene radicals, and substituted versions thereof; and
x is 0, 1, 2 or 3.

14. The film of claim 13, wherein the saturated amide-containing slip agent is selected from the group consisting of lauramide, myristamide, palmitamide, stearamide, behenamide, and mixtures thereof.

15. The film of claim 13, wherein the saturated amide-containing slip agent is selected from stearamide, behenamide, and mixtures thereof.

16. The film of claim 1, where in the film is a blown or cast film.

17. A method of forming a film comprising the steps of:
a) melt blending:
i. a propylene-alpha-olefin copolymer,
comprising propylene-derived units and from 5 to 35 wt %, based on the weight of said copolymer, of units derived from ethylene and/or C4 to C10 alpha-olefins, and
having a melt flow rate, as determined by ASTM D1238 at 230° C., in the range of 0.5 to 50 dg/min and a heat of fusion (Hf) of less than 75 J/g;
ii. and an additive masterbatch, wherein the additive masterbatch comprises:
1. a polymer carrier;
2. a first modifier, comprising a first unsaturated amide-containing slip agent;
3. a second modifier selected from:
A. a second unsaturated amide-containing slip-agent, which may be the same or different than said first unsaturated amide-containing slip agent;
B. a saturated amide-containing slip agent;
C. an antiblock; and
D. a mixture of any two or more of A, B, and C;
wherein said first modifier is present in an amount greater than or equal to 0.10 wt % and said second modifier is present in an amount greater than or equal to 0.50 wt %, both based on the weight of said melt blend;
b) extruding the melt blend through one or more extruder dies; and
c) forming a blown or cast film;
wherein the film has a coefficient of friction of less than 0.80.

18. The method of claim 17, wherein the polymer carrier is selected from the group consisting of polyethylene, low-density polyethylene, linear low density polyethylene, high density polyethylene, polypropylene, propylene-ethylene copolymers, propylene-alpha-olefin copolymers, and mixtures thereof.

19. The method of claim 17, wherein the first and second saturated amide-containing slip agents are the same or different and are selected from compounds having the formulas:
a) RCONH₂ wherein R is a C₅-C₂₃ alkene; and
b) (R′CO)₃₋ₓNR″ₓ, wherein
R′ is a C₁₀ to C₆₀ alkene radicals and substituted versions thereof;
R″ is selected from the group consisting of hydrogen atoms, C₁₀ to C₆₀ alkyl radicals and C₁₀ to C₆₀ alkene radicals, and substituted versions thereof, and
x is 0, 1, 2 or 3.

20. The method of claim 17, wherein the saturated amide-containing slip agents is selected from compounds having the formulas:
a) RCONH₂ wherein R is a C₅-C₂₃ alkyl; and
b) (R′CO)₃₋ₓNR″ₓ, wherein
R′ is a C₁₀ to C₆₀ alkyl radicals and substituted versions thereof,
R″ is selected from the group consisting of hydrogen atoms, C₁₀ to C₆₀ alkyl radicals and C₁₀ to C₆₀ alkene radicals, and substituted versions thereof, and
x is 0, 1, 2 or 3.
